(19) United States
(12) Patent Application Publication
(10) Pub. No.: US 2013/0252587 A1
(43) Pub. Date: Sep. 26, 2013

(54) WIRELESS TERMINAL AND METHOD FOR MANAGING NETWORK CONNECTION USING THE SAME

(71) Applicants: You Chang Ko, Seoul (KR); Yang Hwan Joe, Goyang-si (KR)

(72) Inventors: You Chang Ko, Seoul (KR); Yang Hwan Joe, Goyang-si (KR)

(73) Assignee: SAMSUNG SDS CO., LTD., Seoul (KR)

(21) Appl. No.: 13/991,248

(22) PCT Filed: Dec. 2, 2011
(86) PCT No.: PCT/KR2011/009322

§ 371 Date: Jun. 3, 2013

(30) Foreign Application Priority Data
Dec. 3, 2010 (KR) 10-2010-0122935

(51) Int. Cl. H04W 12/06

(52) U.S. Cl. CPC H04W 12/06
USPC 455/411

(57) ABSTRACT

Provided are a wireless terminal and a method of managing a network connection using the same. The wireless terminal includes a login processor configured to carry out a login procedure including an authentication procedure and a user account verification procedure, a received signal strength indication (RSSI) detector configured to detect an RSSI and check a receiving state, a wireless connection profile manager configured to generate, maintain, or delete a wireless connection profile, and a controller configured to monitor a login process state and a network connection state from the login processor and the RSSI detector and control the login processor or the wireless connection profile manager according to the monitoring result. The method of managing a network connection using the wireless terminal can enhance the security of personal information included in a wireless connection profile and also improve convenience of connection by generating, deleting, or maintaining the wireless connection file according to a network environment.

### CROSS-REFERENCE TO RELATED APPLICATION

This application claims priority to and the benefit of Korean Patent Application No. 10-2010-0122935, filed on Dec. 3, 2010, the disclosure of which is incorporated herein by reference in its entirety.

### BACKGROUND

1. Field of the Invention

The present invention relates to a wireless terminal and a method of managing a network connection using the same, and more particularly, to a wireless terminal capable of enhancing the security of personal information and a method of managing a network connection using the wireless terminal.

2. Discussion of Related Art

Recently, network services based on communication systems are diversifying, and the scale of the market of wireless communication services using wireless terminals such as a smart phone is gradually increasing.

In general, a wireless terminal generates and stores a wireless connection profile including user account information in a network service area. The wireless connection profile that has been stored once is continuously maintained in the wireless terminal. Thus, there is always a security problem that, when the wireless terminal connects to a network with lax security, a malicious program in the wireless terminal or a malicious code parasitic to an application program may leak the personal information in the wireless connection profile to the outside.

### SUMMARY OF THE INVENTION

The inventive concept is directed to providing a method in which a wireless terminal can enhance the security of a wireless connection profile and improve efficiency in operation management according to a network state.

According to an aspect of the inventive concept, there is provided a wireless terminal including: a login processor configured to carry out a login procedure including an authentication procedure and a user account verification procedure; a received signal strength indication (RSSI) detector configured to detect an RSSI and check a receiving state; a wireless connection profile manager configured to generate, maintain, or delete a wireless connection profile; and a controller configured to monitor a login process state and a network connection state from the login processor and the RSSI detector, and control the login processor or the wireless connection profile manager according to the monitoring result.

According to another aspect of the inventive concept, there is provided a method of managing a network connection using a wireless terminal including: when a user account is input by a user, generating, at the wireless terminal, a wireless connection profile corresponding to the user account, and switching to a logged-in state for user authentication and verification of the user account; when the user authentication and the verification of the user account succeed, switching, at the wireless terminal, from the logged-in state to a logged-on state while maintaining the wireless connection profile; and maintaining, at the wireless terminal, the wireless connection profile while an RSSI is detected in the logged-on state, and deleting the wireless connection profile and switching to a logged-off state when no RSSI is detected for a predetermined time.

According to still another aspect of the inventive concept, there is provided a method of managing a network connection using a wireless terminal including: displaying, at the wireless terminal, an indicator icon having a first color during a user authentication procedure; displaying, at the wireless terminal, the indicator icon having a second color during verification of a user account when the user authentication succeeds; when the verification of the user account succeeds, switching, at the wireless terminal, to a logged-on state, and displaying the indicator icon having the second color while an RSSI is detected; and displaying, at the wireless terminal, the indicator icon having a fourth color before a timeout when no RSSI is detected in the logged-on state, and switching to a dormant state and removing the indicator icon when the timeout occurs.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a constitution of a wireless terminal according to an exemplary embodiment of the present invention; and

FIG. 2 is an operational flowchart illustrating a method of managing a network connection using the wireless terminal of FIG. 1.

### DETAILED DESCRIPTION OF EXEMPLARY EMBODIMENTS

Hereinafter, detailed embodiments of the present invention will be described with reference to drawings. However, the embodiments are merely examples and are not to be construed as limiting the present invention.

When it is determined that the detailed description of known art related to the present invention may obscure the gist of the present invention, the detailed description thereof will be omitted. Terminology described below is defined considering functions in the present invention and may vary according to a user's or operator's intention or usual practice. Thus, the meanings of the terminology should be interpreted based on the overall context of the present specification.

The spirit of the present invention is determined by the claims, and the following exemplary embodiments are provided only to efficiently describe the spirit of the present invention to those of ordinary skill in the art.

With reference to the accompanying drawings, a wireless terminal and a method of managing a network connection using the same according to exemplary embodiments of the present invention will be described below.

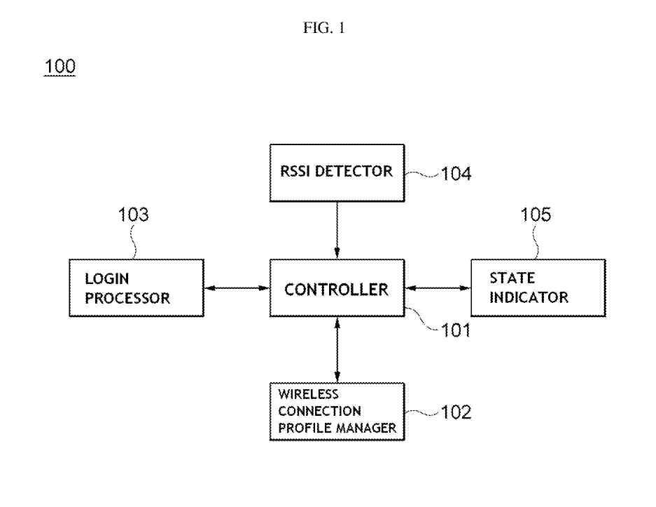

FIG. 1 is a block diagram showing a constitution of a wireless terminal according to an exemplary embodiment of the present invention.

A wireless terminal 100 according to an exemplary embodiment of the present invention includes a controller 101, a wireless connection profile manager 102, a login processor 103, a received signal strength indication (RSSI) detector 104, and a state indicator 105.

The controller 101 functions to centrally control the wireless connection profiler manager 102, the login processor 103, and so on.

The wireless connection profile manager 102 functions to generate, maintain, and delete a wireless connection profile under the control of the controller 101.

Here, the wireless connection profile consists of a set of authentication parameters for a user to connect to a specific network, and includes, for example, a service set identifier (SSID) that is a wireless fidelity (WiFi) network ID, an encryption method (not set in an unsecured network), and additional information dependent on the encryption method (e.g., a user ID and a password).

The login processor 103 performs an authentication procedure and a user account verification procedure of the wireless terminal 100 under the control of the controller 101 in the case of manual login or automatic login.

The RSSI detector 104 detects an RSSI and provides a receiving state of the wireless terminal 100 to the controller 101.

Here, the RSSI is a value indicating the strength of a received signal. For example, detection of no RSSI denotes that the strength of a received signal is 0, and the wireless terminal has moved out of a network service area. Thus, a wireless network connection is impossible, and an authentication procedure cannot be performed.

The state indicator 105 functions to indicate a login process state, a network connection state, etc. of the wireless terminal 100 in different colors.

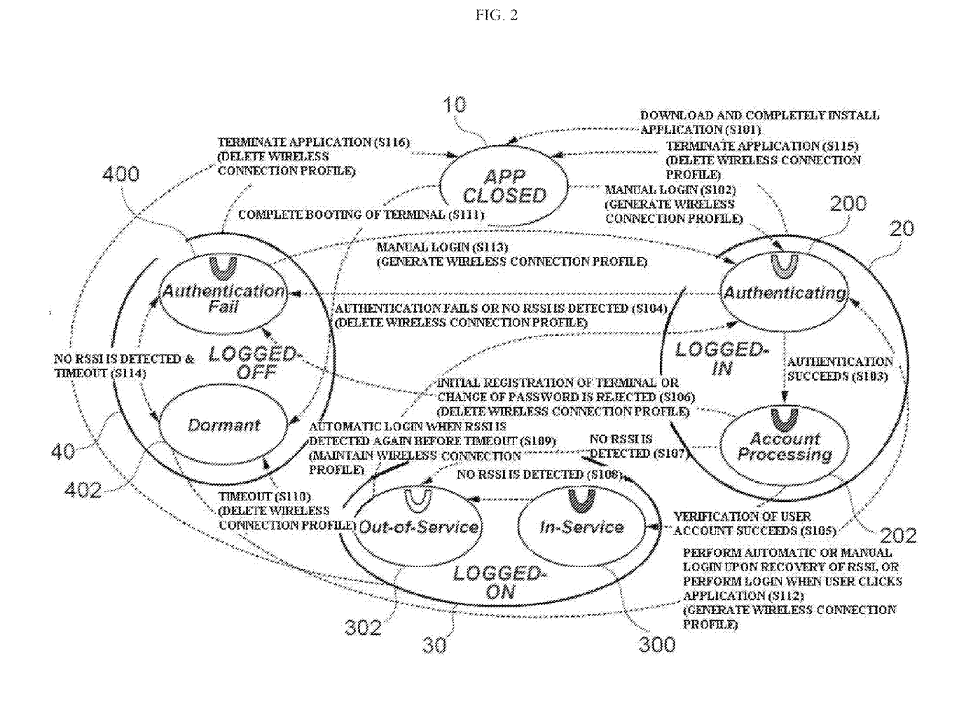

The controller 101 monitors the login process state, the network connection state, etc. of the wireless terminal 100 from the login processor 103 and the RSSI detector 104 in real time, and indicates the current states of the wireless terminal 100 through the state indicator 105. Details of this operation will be described later with reference to FIG. 2.

FIG. 2 is an operational flowchart illustrating a method of managing a network connection using the wireless terminal of FIG. 1.

Referring to FIG. 1 and FIG. 2, first, when a user downloads and then completely installs an application program for network connection management in the wireless terminal 100 (S101), an initial state of the wireless terminal 100 is an application closed state 10. In this state, the application program has been installed in the wireless terminal 100 but not yet been executed. At this time, it is impossible to use a network, and a wireless connection profile has not been generated or has been deleted.

Next, when the user inputs a user account (a user ID and a password) to execute the application program and manually logs in (S102), the wireless terminal 100 switches to a logged-in state 20. At this time, the controller 101 driven by the application program controls the wireless connection profile manager 102 to generate a wireless connection profile, and controls the login processor 103 to perform an authentication procedure and a user account verification procedure of the wireless terminal 100.

The logged-in state 20 is a step for user authentication and account verification, and divided into two sub-states. One is an authenticating state 200 of performing an Institute of Electrical and Electronics Engineers (IEEE) 802.1X user authentication procedure, and the other is an account processing state 202 of verifying a user account.

First, when the wireless connection profile manager 102 generates a wireless connection profile and requests authentication upon manual login of the wireless terminal 100, an authentication procedure is performed on the wireless terminal 100 in the authenticating state 200. When the authentication succeeds (S103), the wireless terminal 100 switches to the account processing state 202. On the other hand, when the authentication fails or no RSSI is detected (S104), the wireless terminal 100 switches to an authentication fail state 400 (S104). At this time, the controller 101 driven by the application program controls the wireless connection profile manager 102 to delete the wireless connection profile. When no RSSI is detected, a platform of the wireless terminal 100 transfers a network disable intent to the application program, and in response to the network disable intent, the application program switches to the authentication fail state 400. An intent denotes an object used when an application program calls a function of another module. For convenience, description will be made here on the basis of the Android platform. However, exemplary embodiments of the present invention are not limited to the Android platform, and needless to say, can be applied to a variety of platforms.

Meanwhile, the wireless terminal 100 displays an indicator icon of a “U” shape for indicating a login process state and a network connection state in different colors on the state indicator 105. The state indicator 105 is controlled by the controller 101 to display the indicator icon in different colors. in accordance with one example, the wireless terminal 100 displays a yellow indicator icon in the authenticating state 200, and a green indicator icon in the account processing state 202. In this state, user authentication has succeeded, and it is possible to basically use the network. In the authentication fail state 400, the wireless terminal 100 displays a red indicator icon. In other words, the controller 101 of the wireless terminal 100 displays the indicator icon in different colors according to login process states or network connection states.

When the user account verification also succeeds (S105) after the success of the user authentication, the wireless terminal 100 switches to a logged-on state 30. On the other hand, when the user rejects a request for initial terminal registration in the account processing state 202, or the user refuses to change the password in the account processing state 202 after expiry of a password change period (S106), the wireless terminal 100 switches to the authentication fail state 400. In other words, when the user account verification fails, the wireless terminal 100 switches to the authentication fail state 400. At this time, the controller 101 driven by the application program controls the wireless connection profile manager 102 to delete the wireless connection profile.

Meanwhile, the logged-on state 30 is a state in which the authentication has succeeded, and it is possible to use the network, and is divided into two sub-states. One is an in-service state 300, and the other is an out-of-service state 302.

In the in-service state 300, it is possible to use the network normally. After the user authentication and the user account verification, the wireless terminal 100 switches from the logged-in state 20 to the in-service state 300 of the logged-on state 30. However, when no RSSI is detected in the account processing state 202 (S107), the wireless terminal 100 may directly switch to the out-of-service state 302 of the logged-on state 30. Even when no RSSI is detected in the in-service state 300 (S108), the wireless terminal 100 switches to the out-of-service state 302. From the viewpoint of the Android platform, the platform generates a network disable intent when no RSSI is detected (or when the wireless terminal 100 moves out of the service area), and in response to the network disable intent, the application program switches to the out-of-service state 302.

In the out-of-service state 302, the network cannot be used temporarily, and the indicator icon turns white. At this time, the controller 101 driven by the application program determines whether or not to delete the wireless connection profile according to whether or not an RSSI is detected again (or whether or not the wireless terminal 100 returns to the service area) before a predetermined time elapses (or before a timeout occurs) in the out-of-service state 302. In other words, when an RSSI is detected again before a timeout, the wireless terminal 100 switches to the logged-in state 20 again by automatically logging in (S109), and maintains the wireless connection profile as it is.

From the viewpoint of the Android platform, the platform generates a network enable intent when an RSSI is detected again before a timeout, and in response to the network enable intent, the controller 101 driven by the application program controls the login processor 103 to perform automatic login, and switches to the authenticating state 200.

On the other hand, when the predetermined time elapses and a timeout occurs (S110), the wireless terminal 100 deletes the wireless connection profile, and switches to a dormant state 402 of a logged-off state 40.

As described above, even when the wireless terminal 100 moves out of the service area in the logged-on state 30, if the wireless terminal 100 returns to the service area before a timeout, the wireless terminal 100 maintains the wireless connection profile, and when the predetermined time elapses and a timeout occurs, the wireless terminal 100 deletes the wireless connection profile, thereby preventing leakage of personal information.

Meanwhile, when booting of the wireless terminal 100 is completed (S111), the wireless terminal 100 switches from the application closed state 10 to the dormant state 402. From the viewpoint of the Android platform, the platform generates a device boot completed intent when the booting of the wireless terminal 100 is completed, and the application program receives the device boot completed intent, and switches to the dormant state 402. The dormant state 402 denotes a state in which, upon booting of the wireless terminal 100, the application can be executed, but the wireless terminal 100 waits for another operation. Since a network connection has been cut off in the dormant state 402, the indicator icon of the “U” shape is not displayed on the state indicator 105 of the wireless terminal 100.

Upon recovery of an RSSI in the dormant state 402, the application program of the wireless terminal 100 receives the network enable intent from the platform and performs automatic login, thereby switching to the authenticating state 200. Here, a login method of the application program may be manual login rather than automatic login, and may be configured to perform login when the application program is clicked (S112). At this time, the controller 101 driven by the application program controls the wireless connection profile manager 102 to generate a wireless connection profile.

Meanwhile, when the user clicks the red indicator icon in the authentication fail state 400, a manual login procedure 5113 is carried out. At this time, the wireless terminal 100 may receive both the user ID and the password and switch to the authenticating state 200, or only receive the password with the user ID stored in advance and switch to the authenticating state 200. On the other hand, when no RSSI is detected in the authentication fail state 400, and no network enable intent is received from the platform before a timeout, the wireless terminal 100 switches to the dormant state 402 (S114). In other words, when a predetermined time elapses in the authentication fail state 400, the wireless terminal 100 switches to the dormant state 402.

The user can terminate the application program in any of the logged-in state 20, the logged-on state 30, and the logged-off state 40 (S115 and S116). At this time, the controller 101 controls the wireless connection profile manager 102 to delete the wireless connection profile, and the wireless terminal 100 switches back to the application closed state 10.

For example, when the user forcibly terminate, the application program by selecting a close function in a menu user interface (UI) of the application program displayed on a screen of the wireless terminal 100 or by using a command of the platform, etc., the controller 101 controls the wireless connection profile manager 102 to delete the wireless connection profile, and terminates operation of the wireless terminal 100.

As described above, the wireless terminal 100 according to an exemplary embodiment of the present invention manages a network connection using the application program classified as a total of seven states including the application closed state 10, the authenticating state 200, the account processing state 202, the in-service state 300, the out-of-service state 302, the authentication fail state 400, and the dormant state 402.

In addition, the method of managing a network connection using a wireless terminal according to an exemplary embodiment of the present invention maintains a wireless connection profile in the authenticating state 200, the account processing state 202, and the in-service state 300, and before a timeout in the out-of-service state 302. When the wireless terminal switches to the other states, the wireless connection profile is deleted, and thereby leakage of personal information included in the wireless connection profile is prevented.

For example, if the wireless terminal were to connect to another network with lax security in the authentication fail state 400 or the dormant state 402 without deleting the wireless connection profile, personal information in the wireless connection profile of the wireless terminal may be leaked to the outside by a malicious code, a malicious program, or so on.

Meanwhile, the method of managing a network connection using a wireless terminal according to an exemplary embodiment of the present invention provides a user with so much convenience that the user can intuitively recognize a network state through an indicator icon displayed in different colors according to network connection states.

For convenience, the description above has been made regarding an application program of a wireless terminal running on the Android-based platform. However, exemplary embodiments of the present invention are not limited to the Android platform, and can be applied to a variety of platform environments. In this case, needless to say, a class, intents, etc. used in the application program should be changed according to each platform.

According to exemplary embodiments of the present invention, it is possible to enhance the security of personal information included in a wireless connection profile and also improve convenience of connection by generating, deleting, or maintaining the wireless connection file according to a network environment.

In addition, exemplary embodiments of the present invention improve noticeability of a wireless terminal using an indicator icon of a “U” shape displayed in different colors according to a network connection state, thereby providing a user with so much convenience that the user can intuitively recognize a current network state.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A wireless terminal, comprising:
a processor configured to carry out a login procedure including an authentication and a user account verification;
a received signal strength indication (RSSI) detector configured to detect an RSSI and check a receiving state;
a wireless connection profile manager configured to generate, maintain, or delete a wireless connection profile; and
a controller configured to monitor a login process state and a network connection state from the processor and the RSSI detector to generate a monitoring result, and control the processor or the wireless connection profile manager according to the monitoring result.

2. The wireless terminal of claim 1, wherein, upon manual login or automatic login, the controller controls the wireless connection profile manager to generate a the wireless connection profile and the processor to perform the login procedure.

3. The wireless terminal of claim 2, wherein, when no RSSI is detected or authentication fails in the authentication, or the user account verification fails, the controller controls the wireless connection profile manager to delete the wireless connection profile.

4. The wireless terminal of claim 3, wherein the failure of the user account verification includes a refusal of a user to initially register the wireless terminal or to change a password.

5. The wireless terminal of claim 1, wherein, when no RSSI is detected for a predetermined time, the controller controls the wireless connection profile manager to delete the wireless connection profile.

6. The wireless terminal of claim 1, wherein, when no RSSI is detected in an in-service state, the controller controls the wireless connection profile manager to maintain the wireless connection profile for a predetermined time.

7. The wireless terminal of claim 1, further comprising a state indicator configured to display a plurality of colors according to login process states and network connection states.

8. A method of managing a network connection using a wireless terminal, comprising:
when a user account is input by a user, generating, at the wireless terminal, a wireless connection profile corresponding to the user account, and switching to a logged-in state for user authentication and verification of the user account;
when the user authentication and the verification of the user account succeed, switching, at the wireless terminal, from the logged-in state to a logged-on state while maintaining the wireless connection profile; and
maintaining, at the wireless terminal, the wireless connection profile while a received signal strength indication (RSSI) is detected in the logged-on state, and deleting the wireless connection profile and switching to a logged-off state when no RSSI is detected for a predetermined time.

9. The method of claim 8, wherein the logged-in state includes:
an authenticating state of performing the user authentication; and
an account processing state of verifying the user account after the user authentication succeeds.

10. The method of claim 9, wherein, when no RSSI is detected or the user authentication fails in the authenticating state, the wireless terminal deletes the wireless connection profile and switches to the logged-off state.

11. The method of claim 9, wherein, when a failure of the user account verification including a refusal of the user to initially register the wireless terminal or to change a password occurs in the account processing state, the wireless terminal deletes the wireless connection profile and switches to the logged-off state.

12. The method of claim 8, wherein the logged-on state includes:
an in-service state in which an RSSI is detected; and
an out-of-service state in which no RSSI is detected.

13. The method of claim 12, wherein, when no RSSI is detected in the in-service state, the wireless terminal switches to the out-of-service state with the wireless connection profile being maintained.

14. The method of claim 13, wherein, when no RSSI is detected for the predetermined time in the out-of-service state, the wireless terminal deletes the wireless connection profile and switches to the logged-off state, and
when the RSSI is detected again before the predetermined time elapses in the out-of-service state, the wireless terminal switches to the logged-in state with the wireless connection profile being maintained.

15. The method of claim 8, wherein the logged-off state includes:
an authentication fail state to which the wireless terminal switches to when the user authentication fails, no RSSI is detected, or the user account verification fails in the logged-in state; and
a dormant state to which the wireless terminal switches to when no RSSI is detected for a predetermined time.

16. The method of claim 15, wherein, when login is performed in the authentication fail state, the wireless terminal generates the wireless connection profile and switches to the logged-in state, and
when no RSSI is detected for the predetermined time, the wireless terminal switches to the dormant state.

17. The method of claim 15, wherein, when no RSSI is detected for the predetermined time in the logged-on state, the wireless terminal deletes the wireless connection profile and switches to the dormant state.

18. The method of claim 15, wherein, when login is performed in the dormant state, the wireless terminal generates the wireless connection profile and switches to the logged-in state.

19. A method of managing a network connection using a wireless terminal, comprising:
displaying, at the wireless terminal, an indicator icon operable to show a first color, a second color, a third color, and a fourth color, the indicator icon showing the color during a user authentication;
displaying, at the wireless terminal, the indicator icon showing the second color during verification of a user account when the user authentication succeeds;
when the user account verification succeeds, switching, at the wireless terminal, to a logged-on state, and displaying the indicator icon having the second color while a received signal strength indication (RSSI) is detected; and
displaying, at the wireless terminal, the indicator icon showing the fourth color before a timeout when no RSSI is detected in the logged-on state, and switching to a dormant state and not displaying the indicator icon when the timeout occurs.

20. The method of claim 19, wherein, when the user authentication fails or no RSSI is detected during the user authentication, or the user account verification fails, the wireless terminal switches to an authentication fail state, and displays the indicator icon showing the third color.

21. The method of claim 20, wherein, when login is performed in the authentication fail state, the wireless terminal performs the user authentication, and displays the indicator icon showing the first color.

22. The method of claim 20, wherein, when no RSSI is detected and a timeout occurs in the authentication fail state, the wireless terminal switches to the dormant state, and does not display the indicator icon.

23. The method of claim 19, wherein, when no RSSI is detected and then the RSSI is detected again before the timeout in the logged-on state, the wireless terminal performs the user authentication, and displays the indicator icon showing the first color.
